(19) United States
(12) Patent Application Publication
(10) Pub. No.: US 2025/0203346 A1
(43) Pub. Date: Jun. 19, 2025

(54) METHOD AND APPARATUS FOR GENERATING TOPOLOGY BASED ON RECOGNITION OF ORBITAL CHARACTERISTICS OF LOW EARTH ORBIT SATELLITE CONSTELLATION SYSTEM, AND STORAGE MEDIUM STORING INSTRUCTIONS TO PERFORM METHOD FOR GENERATING TOPOLOGY

(71) Applicant: AGENCY FOR DEFENSE DEVELOPMENT, Daejeon (KR)

(72) Inventors: Myoung Hun HAN, Daejeon (KR); Dong Won KUM, Daejeon (KR); Bong Soo ROH, Daejeon (KR); Sang Jin LEE, Daejeon (KR); Kil Soo JEONG, Daejeon (KR)

(21) Appl. No.: 18/610,962

(22) Filed: Mar. 20, 2024

(30) Foreign Application Priority Data
Mar. 21, 2023 (KR) 10-2023-0036917

(51) Int. Cl. H04W 8/22; G01S 19/01; H04W 64/00; H04W 84/06

(52) U.S. Cl. CPC H04W 8/22; G01S 19/01; H04W 64/003; H04W 84/06

(57) ABSTRACT

Proposed is a topology generation device for generating topology for a low earth orbit satellite constellation system including a plurality of low earth orbit satellites to be operated in a plurality of orbits. The topology generation device may include a memory storing one or more instructions and a processor executing the one or more instructions. The processor may collect orbit information for the plurality of orbits from a ground station, collect status information including status of links between the plurality of low earth orbit satellites, and generate location information for a first low earth orbit satellite by predicting a location of the first low earth orbit satellite based on the orbit information. The processor may also generate a network topology for the low earth orbit satellite constellation system based on the location information for the first low earth orbit satellite and the status information.

### CROSS-REFERENCE TO RELATED APPLICATION

This application claims priority to Korean Patent Application No. 10-2023-0036917 filed on Mar. 21, 2023. The entire contents of the application on which the priority is based are incorporated herein by reference.

### BACKGROUND

### Technical Field

The present disclosure relates to topology generation technology for low earth orbit satellite systems.

### Description of Related Technology

Low earth orbit satellites have advantages of lower latency than existing mid-orbit/high-orbit satellites, wide coverage, and miniaturization, and lead the next-generation communication service paradigm combined with terrestrial mobile communications because there are almost no space constraints. In addition, the next-generation 6G network is technology for space Internet services and next-generation 3D mobile communications, and research on low earth orbit satellites to implement non-terrestrial networks is being actively conducted.

Nevertheless, since existing algorithms fail to consider orbital characteristics of low earth orbit satellite networks, there are limitations in reflecting changes in time-varying topology based on actual environmental information.

### SUMMARY

Embodiments of the present disclosure provide a method and device for generating topology information based on recognition of orbital characteristics to generate topology information requiring high reliability and precision in a space network environment in which a plurality of low earth orbit satellites is connected through an inter-satellite link (ISL).

The aspects of the present disclosure are not limited to the foregoing, and other aspects not mentioned herein will be clearly understood by those skilled in the art from the following description.

In accordance with an aspect of the present disclosure, there is provided a topology generation device for generating topology for a low earth orbit satellite constellation system including a plurality of low earth orbit satellites to be operated in a plurality of orbits, the device comprises: a memory storing one or more instructions; and a processor executing the one or more instructions stored in the memory, wherein the instructions, when executed by the processor, cause the processor to: collect orbit information for the plurality of orbits in the low earth orbit satellite constellation system from a ground station; collect status information including statuses of links between the plurality of low earth orbit satellites from the ground station or the plurality of low earth orbit satellites; generate location information for a first low earth orbit satellite including the topology generation device among the plurality of low earth orbit satellites by predicting a location of the first low earth orbit satellite based on the orbit information for the plurality of orbits; and generate a network topology for the low earth orbit satellite constellation system based on the location information for the first low earth orbit satellite and the status information including the statuses of links between the plurality of low earth orbit satellites.

The processor may be configured to collect GPS information from a global positioning system (GPS).

The processor may be configured to share the orbit information for the plurality of orbits in the low earth orbit satellite constellation system and the status information including the statuses of links between the plurality of low earth orbit satellites with the plurality of low earth orbit satellites.

The plurality of low earth orbit satellites may be configured to communicate with at least one of neighboring satellites connected through an inter-plane inter-satellite link or an intra-plane inter-satellite link.

The plurality of low earth orbit satellites may be configured to transmit the orbit information and the status information to the at least one of neighboring satellites connected through the inter-plane inter-satellite link and to check whether the at least one of neighboring satellites connected through the inter-plane inter-satellite link receive the orbit information and the status information when the plurality of low earth orbit satellites communicates with the at least one of neighboring satellites connected through the inter-plane inter-satellite link. Also, the plurality of low earth orbit satellites may be configured to transmit the orbit information and the status information to the at least one of neighboring satellites connected through the intra-plane inter-satellite link without checking whether the at least one of neighboring satellites connected through the intra-plane inter-satellite link receive the orbit information and the status information when the plurality of low earth orbit satellites communicates with the at least one of neighboring satellites connected through the intra-plane inter-satellite link.

The processor may be configured to calculate the location of the first low earth orbit satellite based on the orbit information and to determine whether the orbit information is receivable, and generate updated orbit information by updating the orbit information based on the GPS information whenever the processor determines that the orbit information is not receivable.

The processor may be configured to calculate the location of the first low earth orbit satellite by applying six orbital elements of two line elements (TLE) information and simplified general perturbations 4 (SGP4) algorithm.

The processor may be configured to generate topology calibration information by performing topology calibration based on the updated orbit information and the status information, and generate the network topology for the low earth orbit satellite constellation system based on the location information and the topology calibration information.

In accordance with another aspect of the present disclosure, there is provided a topology generating method to be performed a topology generation device for generating topology for a low earth orbit satellite constellation system including a plurality of low earth orbit satellites to be operated in a plurality of orbits, the method comprises: collecting orbit information for the plurality of orbits in the low earth orbit satellite constellation system from a ground station and collecting status information including statuses of links between the plurality of low earth orbit satellites from the ground station or the plurality of low earth orbit satellites; generating location information for a first low earth orbit satellite including the topology generation device among the plurality of low earth orbit satellites by predicting a location of the first low earth orbit satellite based on the basis of the orbit information for the plurality of orbits; and generating a network topology for the low earth orbit satellite constellation system based on the location information for the first low earth orbit satellite and the status information including the statuses of links between the plurality of low earth orbit satellites.

The method further comprises collecting GPS information for the first low earth orbit satellite from a GPS; updating the location information using the GPS information; modifying the location information using the orbit information; and updating the network topology using the status information.

The method further comprises sharing the orbit information and the status information with the plurality of low earth orbit satellites.

The plurality of low earth orbit satellites may be configured to communicate with at least one of neighboring satellites connected through an inter-plane inter-satellite link or an intra-plane inter-satellite link.

The method further comprises transmitting the orbit information and the status information to the at least one of neighboring satellites connected through the inter-plane inter-satellite link and checking whether the at least one of neighboring satellites connected through the inter-plane inter-satellite link receive the orbit information and the status information when the plurality of low earth orbit satellites communicates with the at least one of neighboring satellites connected through the inter-plane inter-satellite link, and transmitting the orbit information and the status information to the at least one of neighboring satellites connected through the intra-plane inter-satellite link without checking whether the at least one of neighboring satellites connected through the intra-plane inter-satellite link receive the orbit information and the status information when the plurality of low earth orbit satellites communicates with the at least one of neighboring satellites connected through the intra-plane inter-satellite link.

The generating of the location information may include calculating the location of the first low earth orbit satellite based on the orbit information, determining whether the orbit information is receivable, and generating updated orbit information by updating the orbit information based on the GPS information upon determining the orbit information is not receivable.

The generating of the location information may include calculating the location of the first low earth orbit satellite by applying six orbital elements of TLE information and SGP4 algorithm.

The generating of the network topology may include generating topology calibration information by performing topology calibration based on the updated orbit information and the status information; and generating the network topology for the low earth orbit satellite constellation system based on the location information and the topology calibration information.

In accordance with another aspect of the present disclosure, there is provided a non-transitory computer readable storage medium storing computer executable instructions, wherein the instructions, when executed by a processor, cause the processor to perform a method for generating topology for a low earth orbit satellite constellation system including a plurality of low earth orbit satellites to be operated in a plurality of orbits, the method comprising: collecting orbit information for the plurality of orbits in the low earth orbit satellite constellation system from a ground station and collecting status information including statuses of links between the plurality of low earth orbit satellites from the ground station or the plurality of low earth orbit satellites; generating location information for a first low earth orbit satellite including a topology generation device for generating topology among the plurality of low earth orbit satellites by predicting a location of the first low earth orbit satellite based on the orbit information for the plurality of orbits; and generating a network topology for the low earth orbit satellite constellation system based on the location information for the first low earth orbit satellite and the status information including the statuses of links between the plurality of low earth orbit satellites.

According to an embodiment of the present disclosure, a reliable path search can be performed by predicting changes in a time-varying topology for a low earth orbit satellite constellation network to achieve a network configuration with low delay and high reliability. In addition, according to an embodiment of the present disclosure, topology information can be generated and managed adaptively to changes in a network even in a system similar to the characteristics of a low earth orbit satellite constellation network.

### BRIEF DESCRIPTION OF THE DRAWINGS

FIG. 1 is a conceptual diagram for describing an inter-satellite link of a low earth orbit satellite constellation system applied to an embodiment of the present disclosure.

FIG. 2 is a block diagram of a topology generation device 10 based on recognition of orbital characteristics of the low earth orbit satellite constellation system according to an embodiment of the present disclosure.

FIG. 3 is a functional block diagram of an orbit information collector 100 in the topology generation device 10 of FIG. 2.

FIG. 4 is a functional block diagram of a satellite information manager 110 in the topology generation device 10 of FIG. 2.

FIG. 5 is a functional block diagram of a topology manager 120 in the topology generation device 10 of FIG. 2.

FIG. 6 is a conceptual diagram illustrating a topology information generation structure of the topology generation device 10 based on orbital characteristic recognition of a low earth orbit satellite constellation system according to an embodiment of the present disclosure.

FIG. 7 shows a comparison of an intra-plane which describes an intra-plane inter-satellite link and an inter-plane which describes an inter-plane inter-satellite link of the low earth orbit satellite constellation system according to an embodiment of the present disclosure.

FIG. 8 is a diagram illustrating a satellite location tracking method of the topology generation device 10 of a low earth orbit satellite constellation system according to an embodiment of the present disclosure.

FIG. 9 is a diagram illustrating a location tracking calibration method of the topology generation device 10 of the low earth orbit satellite constellation system according to an embodiment of the present disclosure.

FIG. 10 is a diagram illustrating topology information generated through the topology manager 120 of the topology generation device 10 of the low earth orbit satellite constellation system according to an embodiment of the present disclosure.

FIG. 11 is a diagram illustrating an example of a case of predicting an ISL state based on a satellite location.

### DETAILED DESCRIPTION

The advantages and features of the embodiments and the methods of accomplishing the embodiments will be clearly understood from the following description taken in conjunction with the accompanying drawings. However, embodiments are not limited to those embodiments described, as embodiments may be implemented in various forms. It should be noted that the present embodiments are provided to make a full disclosure and also to allow those skilled in the art to know the full range of the embodiments. Therefore, the embodiments are to be defined only by the scope of the appended claims.

Terms used in the present specification will be briefly described, and the present disclosure will be described in detail.

In terms used in the present disclosure, general terms currently as widely used as possible while considering functions in the present disclosure are used. However, the terms may vary according to the intention or precedent of a technician working in the field, the emergence of new technologies, and the like. In addition, in certain cases, there are terms arbitrarily selected by the applicant, and in this case, the meaning of the terms will be described in detail in the description of the corresponding invention. Therefore, the terms used in the present disclosure should be defined based on the meaning of the terms and the overall contents of the present disclosure, not just the name of the terms.

When it is described that a part in the overall specification “includes” a certain component, this means that other components may be further included instead of excluding other components unless specifically stated to the contrary.

In addition, a term such as a “unit” or a “portion” used in the specification means a software component or a hardware component such as FPGA or ASIC, and the “unit” or the “portion” performs a certain role. However, the “unit” or the “portion” is not limited to software or hardware. The “portion” or the “unit” may be configured to be in an addressable storage medium, or may be configured to reproduce one or more processors. Thus, as an example, the “unit” or the “portion” includes components (such as software components, object-oriented software components, class components, and task components), processes, functions, properties, procedures, subroutines, segments of program code, drivers, firmware, microcode, circuits, data, database, data structures, tables, arrays, and variables. The functions provided in the components and “unit” may be combined into a smaller number of components and “units” or may be further divided into additional components and “units”.

Hereinafter, the embodiment of the present disclosure will be described in detail with reference to the accompanying drawings so that those of ordinary skill in the art may easily implement the present disclosure. In the drawings, portions not related to the description are omitted in order to clearly describe the present disclosure.

A low earth orbit satellite constellation system deploys a large number of low earth orbit satellites and thus has the advantage of having a shorter propagation delay time and lower required communication signal output than geostationary satellite systems, enabling personal mobile terminal services. The low earth orbit satellite constellation system is composed of tens or hundreds of satellites, and has an inter-satellite link (ISL) for a network configuration between satellites, a spot beam for satellite-ground connection, and a feeder link for ground station communication.

In general, an inter-satellite link is constructed using high-speed laser communication and performs a pointing, acquisition, and tracking (PAT) procedure for tracking the constantly changing location of the other satellites and adjusting an antenna direction in order to maintain a stable communication link. Here, the inter-satellite link between a satellite located in a seam area where orbital directions intersect and a satellite located in a pole area where orbital intersection occurs may be temporarily disconnected, and such a regular and periodic link disconnection affects topology changes, resulting in significant deterioration of network stability. In addition, a satellite-to-ground link is composed of microwaves and a feeder link for connection to ground terminals, which reduces a connectable duration of the satellite-to-ground link. Accordingly, periodic network disconnections and topology changes occur as in inter-satellite links, resulting in network performance deterioration.

It is difficult to apply topology creation/management techniques used in routing protocols such as open shortest path first (OSPF) protocol and enhanced interior gateway routing protocol (EIGRP) applied to existing terrestrial Internet environments to such link disconnection and dynamic topology characteristics of low earth orbit satellite constellation networks, and in particular, in a case where high reliability and high precision of data traffic are required, it is difficult to establish stable routing due to frequent link disconnection and retransmission, making it difficult to provide service QoS.

In addition, in OSPF, EIGRP, and the like which are operated in existing wired networks, topology creation and link disconnection are recognized by periodically exchanging a Hello message and a topology update (TU) message. Since existing topology creation/management methods based on periodic message exchange and success count are not suitable for the environment of a satellite constellation network with regularity and periodicity, a topology creation/maintenance method based on the characteristics of the satellite constellation network is required.

Accordingly, an embodiment of the present disclosure proposes a topology information generation method and device based on recognition of orbital characteristics for generating topology information requiring high reliability and high precision in a space network environment in which a plurality of low earth orbit satellites is connected through ISL.

Hereinafter, embodiments of the present disclosure will be described in detail with reference to the attached drawings.

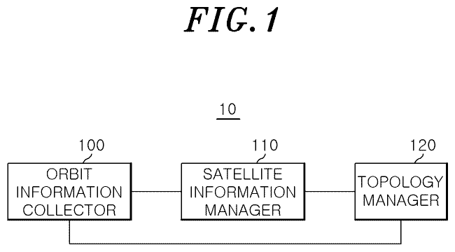

FIG. 1 is a conceptual diagram for describing an inter-satellite link of a low earth orbit satellite constellation system applied to an embodiment of the present disclosure.

As shown in FIG. 1, the low earth orbit satellite constellation system applied to the embodiment of the present disclosure may be configured such that a plurality of low earth orbit satellites is operated through a plurality of orbits, and each low earth orbit satellite can perform data communication with a neighboring satellite through an inter-satellite link between orbits and an inter-satellite link within an orbit.

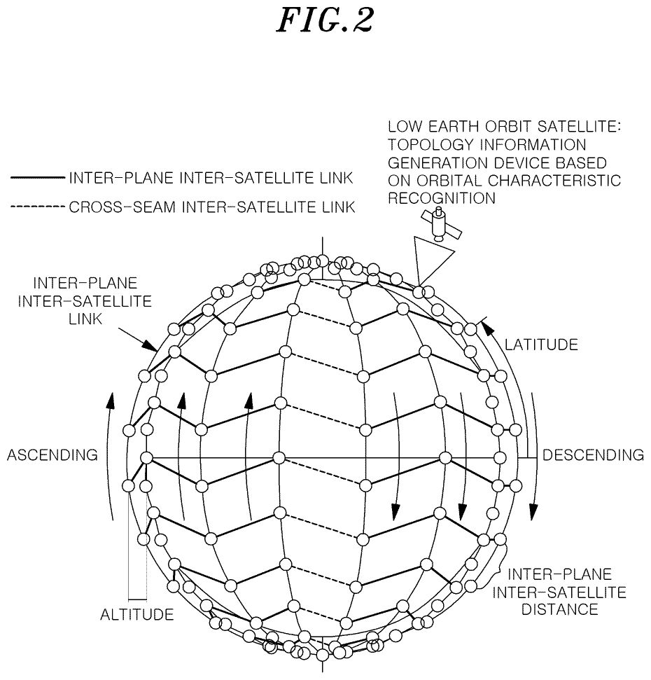

FIG. 2 is a block diagram of a topology generation device 10 based on recognition of orbital characteristics of the low earth orbit satellite constellation system according to an embodiment of the present disclosure.

As shown in FIG. 2, the topology generation device 10 based on recognition of orbital characteristics may include an orbit information collector 100, a satellite information manager 110, and a topology manager 120.

The orbit information collector 100 may collect orbit information from a ground station and collect status information from the ground station and a plurality of low earth orbit satellites.

The satellite information manager 110 may generate location information by tracking the location of an arbitrary low earth orbit satellite on the basis of the orbit information.

The topology manager 120 may generate a network topology for the low earth orbit satellite constellation system on the basis of the location information and the status information.

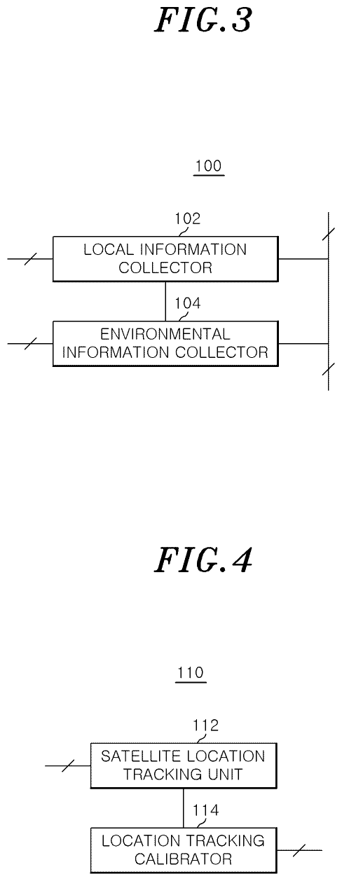

FIG. 3 is a functional block diagram of the orbit information collector 100 in the topology generation device 10 of FIG. 2.

As shown in FIG. 3, the orbit information collector 100 may include a local information collector 102 and an environmental information collector 104.

The local information collector 102 may collect GPS information from a global positioning system (GPS) and provide the GPS information to the satellite information manager 110.

The environmental information collector 104 may provide orbit information to the satellite information manager 110 and provide status information to the topology manager 120.

Here, the orbit information collector 100 can share the orbit information and status information with a plurality of low earth orbit satellites, and the plurality of low earth orbit satellites can perform data communicate with neighboring satellites through any one of an inter-plane inter-satellite link or an intra-plane inter-satellite link.

A process of sharing orbit information and status information and then checking reception from a neighboring satellite can be performed in a case where data communication is performed through an inter-plane inter-satellite link, and a process of sharing the orbit information and status information and then not checking reception from a neighboring satellite can be performed in a case where data communication is performed through an intra-plane inter-satellite link.

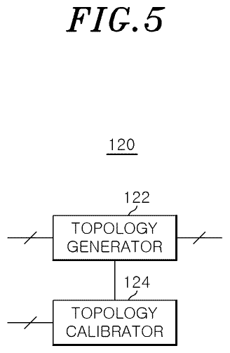

FIG. 4 is a functional block diagram of the satellite information manager 110 in the topology generation device 10 of FIG. 2.

As shown in FIG. 4, the satellite information manager 110 may include a satellite location tracking unit 112 and a location tracking calibrator 114.

The satellite location tracking unit 112 may calculate the location of an arbitrary low earth orbit satellite on the basis of orbit information and determine whether orbit information can be received.

Here, the satellite location tracking unit can calculate the location of an arbitrary low earth orbit satellite by applying six orbit elements of two line elements (TLE) information and the simplified general perturbations 4 (SGP4) algorithm.

When the satellite location tracking unit 112 determines that orbit information cannot be received, the location tracking calibrator 114 may generate updated orbit information obtained by updating the orbit information on the basis of GPS information.

FIG. 5 is a functional block diagram of the topology manager 120 in the topology generation device 10 of FIG. 2.

As shown in FIG. 5, the topology manager 120 may include a topology generator 122 and a topology calibrator 124.

The topology generator 122 may generate a network topology for the low earth orbit satellite constellation system on the basis of location information and topology calibration information of the topology calibrator 124 which will be described later.

The topology calibrator 124 may generate the topology calibration information by performing topology calibration on the basis of updated orbit information and status information. The generated topology calibration information may be provided to the topology generator 122.

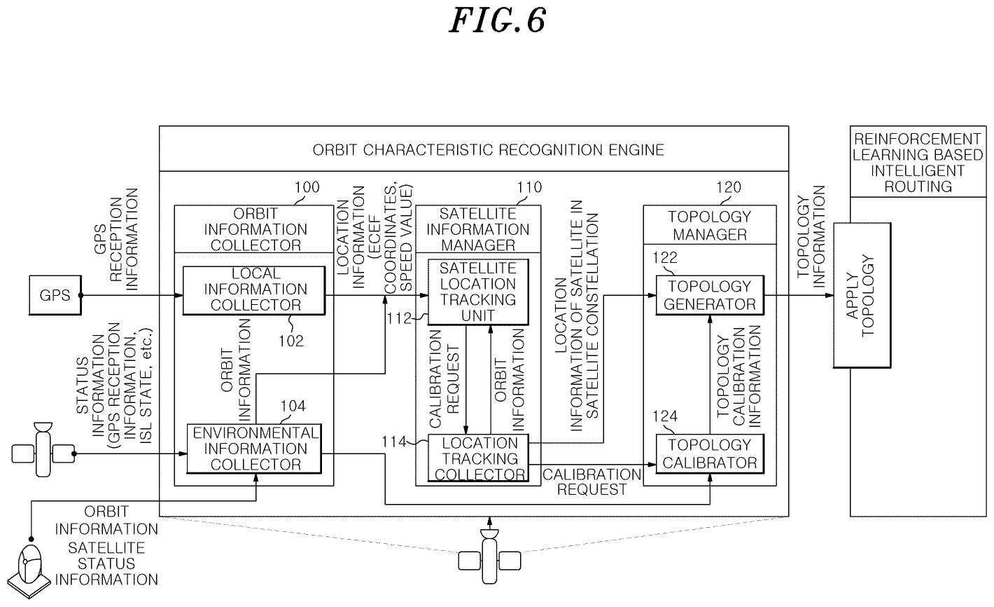

FIG. 6 is a conceptual diagram illustrating a topology information generation structure of the topology generation device 10 based on recognition of orbital characteristics of the low earth orbit satellite constellation system according to an embodiment of the present disclosure.

First, the orbit information collector 100 serves to collect orbit information from the ground for tracking locations of satellites in a satellite constellation and to collect status information from the ground and satellites for monitoring topology changes in the satellite constellation. To track the location of a satellite, the location of the satellite can be calculated using six orbital elements of orbit information. These six orbital elements are as shown in Table 1.

TABLE 1

| Elements | Description | Influence factors |
|---|---|---|
| Semi-major axis | Radius of the major axis of the orbital | Moving speed |
| | ellipse | |
| Inclination | Orbital inclination angle | Observation range varies |
| | | depending on inclination |
| | | angle. |
| Right ascension of | Longitude from 0 degrees to 360 | The direction of |
| the ascending node | degrees from the reference direction to | movement of a satellite |
| (RAAN) | the ascending node of the orbit on the | can be estimated. |
| | equatorial plane | |
| Eccentricity | The shape of a trajectory and how much | The shape is closer to a |
| | the shape of the trajectory deviates | circle as the eccentricity is |
| | from a circle | closer to 0, 0 to 1 indicate |
| | | an elliptical orbit, and 1 or |
| | | more indicate a hyperbolic |
| | | orbit. |
| Argument of perigee | The point at which an object orbiting the | The direction of the ellipse |
| | Earth is closest to the central body when | in the orbital plane is |
| | orbiting the orbit | determined. |
| True anomaly | The angle formed between orbital | The location of an object |
| | periapsis and an object orbiting the | at a specific time is |
| | Earth | determined. |
| | Actual flight angle | |

The status information in Table 1 can be used to predict locations of satellites and connectivity thereof on the basis of orbit information from the ground.

In order for satellites in a satellite constellation to generate topology information, it is necessary to collect orbit information, status information, etc., and to this end, information sharing between satellites needs to be achieved. When satellites share information in order to generate a topology, overhead occurs within the satellite constellation. To reduce this, the present disclosure defines a sharing procedure that takes orbital characteristics into account.

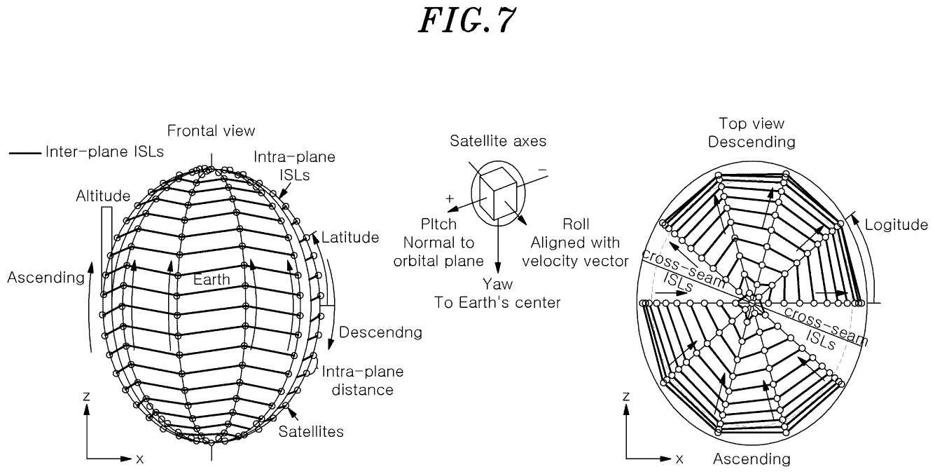

FIG. 7 shows a comparison of an intra-plane which describes an intra-plane inter-satellite link and an inter-plane which describes an inter-plane inter-satellite link of the low earth orbit satellite constellation system according to an embodiment of the present disclosure.

As can be ascertained from FIG. 7, intra-plane ISLs are stably maintained unless disconnection due to a satellite device error occurs because satellites belonging to an orbital plane move in the same direction and the spacing between satellites rarely changes. On the other hand, in the case of inter-plane ISLs, if satellites located in each orbital plane move in different directions, connection target satellites frequently change, which leads to a reduction in the connection duration. Even in the case of the same movement direction, links become incomplete due to changes in links caused by cross-seam inter-satellite links as satellites pass over the polar region and excessive Doppler influence due to incoming satellites. Considering the characteristic that intra-plane ISLs have higher link stability than inter-plane ISLs, the information sharing procedure is defined as follows.
For intra-plane information sharing, ACK is not checked after propagation: Since the link is determined to be relatively stable, reception of information is not checked after propagation.
For inter-plane information sharing, ACK is checked after propagation: Since the link is determined to be unstable, reception of information is checked after propagation.

Meanwhile, location tracking of satellites is essential in order for an orbital characteristic recognition engine to generate/maintain the latest topology information.

Satellite location tracking is performed on the basis of collected orbit information, and in the present disclosure, locations of satellites can be calculated by applying six orbital elements of TLE information as shown in Table 1 and the SGP4 algorithm.

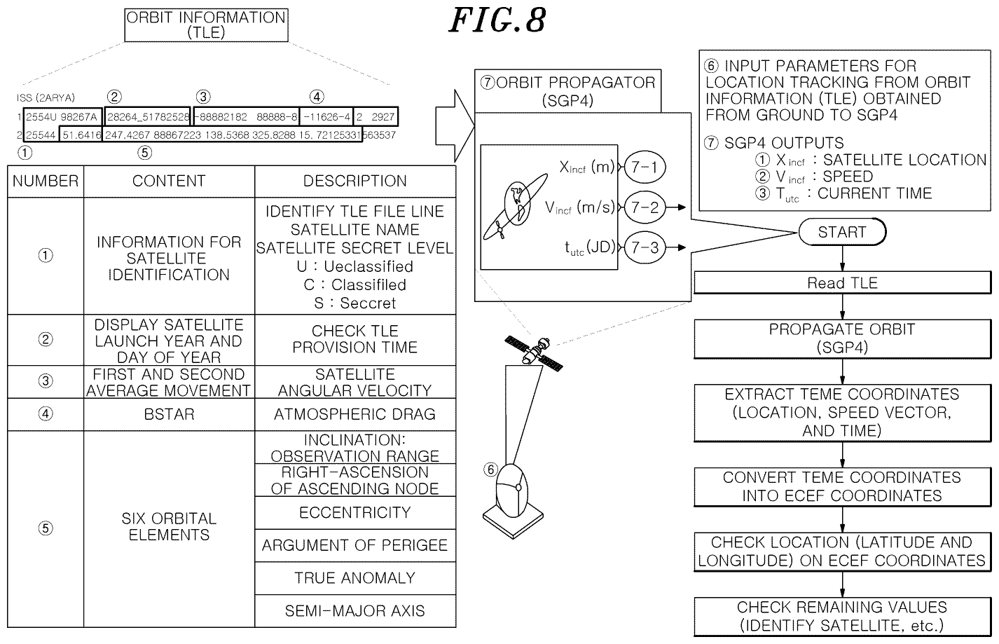

FIG. 8 is a diagram illustrating an exemplary satellite location tracking method of the topology generation device 10 of the low earth orbit satellite constellation system according to an embodiment of the present disclosure.

As illustrated in FIG. 8, when a satellite is in a state where signals can be received from the ground after being placed in an orbit, an orbital characteristic recognition engine algorithm collects orbit information from the ground and performs location tracking by time zone with respect to the satellite on the basis of the location and speed of the satellite extracted through the orbital propagator (SGP4) and the current time.

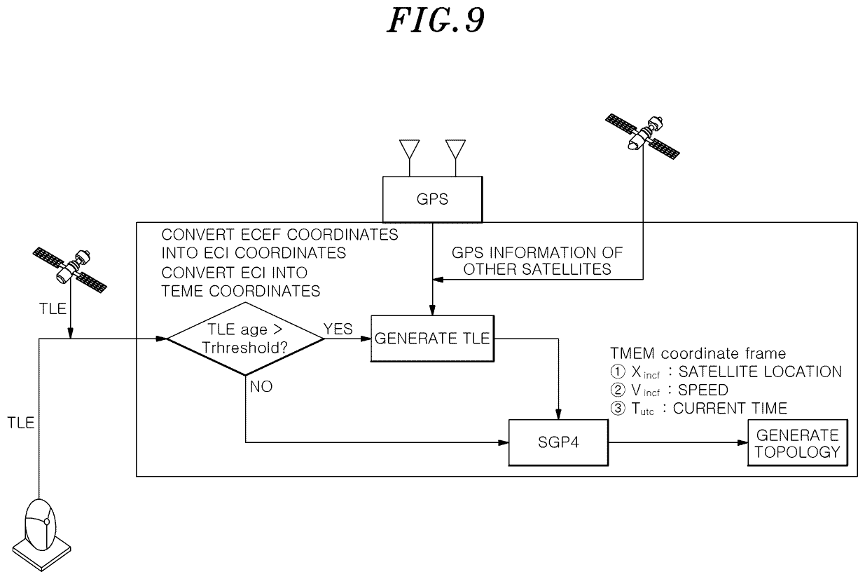

Since satellite location tracking is basically calculated based on past orbit information, an error range increases over time, which increases inaccuracy in topology information, and thus a calibration procedure is required to reduce the error range. In the present disclosure, when orbit information cannot be received from the ground within a set update time for location tracking calibration, each satellite can generate new orbit information through navigation signals received through a GPS receiver, as illustrated in FIG. 9, to reduce the location tracking error range. FIG. 9 is a diagram illustrating a location tracking calibration method of the topology generation device 10 of the low earth orbit satellite constellation system according to an embodiment of the present disclosure.

On the other hand, topology information can be generated on the basis of a link between satellites in the satellite constellation and link status information on the basis of information on the satellites generated through the aforementioned procedure.

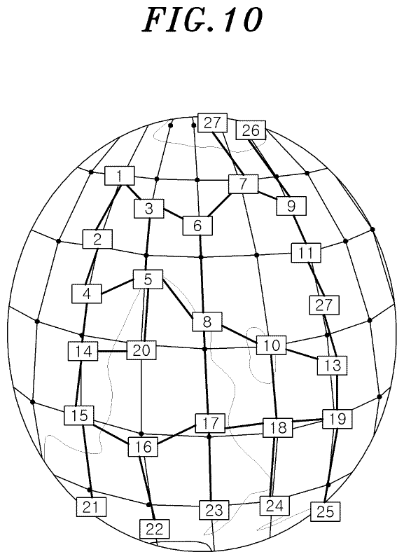

FIG. 10 is a diagram illustrating topology information generated through the topology manager 120 of the topology generation device 10 of the low earth orbit satellite constellation system according to an embodiment of the present disclosure, and Table 2 below shows an example of such topology information.

TABLE 2

Neighboring satellite information

| Satellite | Number | Satellite | Queuing | |
|---|---|---|---|---|
| identifier | of hops | identifier | delay | Duration |
| 1 | 1 hop | 2, 3 | 1 ms | 241 s |
| | | | 3 ms | 230 s |
| | 2 hops | 4, 5, 6 | 2 ms | 233 s |
| | | | 1 ms | 238 s |
| | | | 2 ms | 231 s |
| | . . . | . . . | . . . | . . . |

. . .

As shown in FIG. 10 and Table 2, the satellite identifier is a unique ID of a satellite that is a subject of data transmission, and the neighboring satellite information represents information on satellites through which data is transmitted from the satellite that is the subject of data transmission to a destination satellite. Here, the number of hops represents the number of inter-satellite links (1 hop) required to reach the corresponding satellite. Queuing delay refers to queuing delay by time, and can be defined by reflecting hardware processing delay (PD) and link propagation delay (PPD).

Queuing delay QDi(t) can be calculated through the following Equation 1.

$${QD}_{i} ( t ) = {\sum }_{v} ( \frac{1}{1 - {u}_{link}} ) * ( \frac{PacketSize ( t )}{{LinkBW}_{i} ( t )} ) \qquad [ Equation 1 ]$$

In Equation 1, uₗᵢₙₖ is defined as the average link utilization of link i, and can be calculated through PacketSize(t), which indicates a packet size per hour, and LinkBWᵢ(t), which indicates a link bandwidth per hour. The link duration may represent a duration of an inter-satellite link.

In an embodiment of the present disclosure, location tracking for satellites in a satellite constellation can be performed on the basis of orbit information collected from the ground, and topology information can be generated on the basis of location tracking information. In the case of orbit information collected from the ground, if the orbit information is not updated within a set time, errors with respect to location information may be accumulated over time, making it impossible to generate accurate topology information. For this reason, in the embodiment of the present disclosure, a procedure for generating orbit information in preparation for the case where orbit information cannot be received from the ground, and topology calibration is performed.

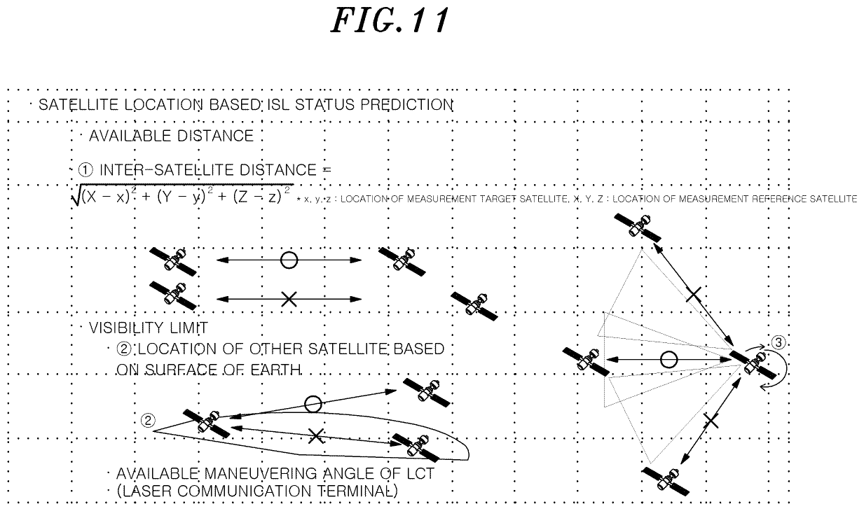

FIG. 11 is a diagram illustrating a case in which an ISL state is predicted on the basis of satellite locations.

As shown in FIG. 11, even in the case of an inter-satellite link (ISL), connectivity is predicted based on location information, and thus, it is difficult to respond to disconnection due to malfunction of an actual device. An embodiment of the present disclosure is characterized by collecting status information on satellites in a satellite constellation from neighboring satellites and determining actual availability of ISL to calibrate topology information.

According to the embodiment of the present disclosure described above, reliable route search can be performed by predicting changes in the time-varying topology for the low earth orbit satellite constellation network, thereby enabling a low-latency highly reliable network configuration, and it is expected that a system similar to the characteristics of the low earth orbit satellite constellation network will be able to generate and manage topology information adaptively to changes in the network.

Combinations of steps in each flowchart attached to the present disclosure may be executed by computer program instructions. Since the computer program instructions can be mounted on a processor of a general-purpose computer, a special purpose computer, or other programmable data processing equipment, the instructions executed by the processor of the computer or other programmable data processing equipment create a means for performing the functions described in each step of the flowchart. The computer program instructions can also be stored on a computer-usable or computer-readable storage medium which can be directed to a computer or other programmable data processing equipment to implement a function in a specific manner. Accordingly, the instructions stored on the computer-usable or computer-readable recording medium can also produce an article of manufacture containing an instruction means which performs the functions described in each step of the flowchart. The computer program instructions can also be mounted on a computer or other programmable data processing equipment. Accordingly, a series of operational steps are performed on a computer or other programmable data processing equipment to create a computer-executable process, and it is also possible for instructions to perform a computer or other programmable data processing equipment to provide steps for performing the functions described in each step of the flowchart.

In addition, each step may represent a module, a segment, or a portion of codes which contains one or more executable instructions for executing the specified logical function(s). It should also be noted that in some alternative embodiments, the functions mentioned in the steps may occur out of order. For example, two steps illustrated in succession may in fact be performed substantially simultaneously, or the steps may sometimes be performed in a reverse order depending on the corresponding function.

The above description is merely exemplary description of the technical scope of the present disclosure, and it will be understood by those skilled in the art that various changes and modifications can be made without departing from original characteristics of the present disclosure. Therefore, the embodiments disclosed in the present disclosure are intended to explain, not to limit, the technical scope of the present disclosure, and the technical scope of the present disclosure is not limited by the embodiments. The protection scope of the present disclosure should be interpreted based on the following claims and it should be appreciated that all technical scopes included within a range equivalent thereto are included in the protection scope of the present disclosure.

What is claimed is:

1. A topology generation device for generating topology for a low earth orbit satellite constellation system including a plurality of low earth orbit satellites to be operated in a plurality of orbits, the device comprising:
a memory storing one or more instructions; and
a processor executing the one or more instructions to:
collect orbit information for the plurality of orbits in the low earth orbit satellite constellation system from a ground station;
collect status information including statuses of links between the plurality of low earth orbit satellites from the ground station or the plurality of low earth orbit satellites;
generate location information for a first low earth orbit satellite including the topology generation device among the plurality of low earth orbit satellites by predicting a location of the first low earth orbit satellite based on the orbit information for the plurality of orbits; and
generate a network topology for the low earth orbit satellite constellation system based on the location information for the first low earth orbit satellite and the status information including the statuses of links between the plurality of low earth orbit satellites.

2. The topology generation device of claim 1, wherein the processor is configured to collect GPS information from a global positioning system (GPS).

3. The topology generation device of claim 2, wherein the processor is configured to share the orbit information for the plurality of orbits in the low earth orbit satellite constellation system and the status information including the statuses of links between the plurality of low earth orbit satellites with the plurality of low earth orbit satellites.

4. The topology generation device of claim 3, wherein the plurality of low earth orbit satellites are configured to communicate with at least one of neighboring satellites connected through an inter-plane inter-satellite link or an intra-plane inter-satellite link.

5. The topology generation device of claim 4, wherein the plurality of low earth orbit satellites are configured to transmit the orbit information and the status information to the at least one of neighboring satellites connected through the inter-plane inter-satellite link and to check whether the at least one of neighboring satellites connected through the inter-plane inter-satellite link receive the orbit information and the status information when the plurality of low earth orbit satellites communicates with the at least one of neighboring satellites connected through the inter-plane inter-satellite link, and
wherein the plurality of low earth orbit satellites are configured to transmit the orbit information and the status information to the at least one of neighboring satellites connected through the intra-plane inter-satellite link without checking whether the at least one of neighboring satellites connected through the intra-plane inter-satellite link receive the orbit information and the status information when the plurality of low earth orbit satellites communicates with the at least one of neighboring satellites connected through the intra-plane inter-satellite link.

6. The topology generation device of claim 2, wherein the processor is configured to calculate the location of the first low earth orbit satellite based on the orbit information and to determine whether the orbit information is receivable, and generate updated orbit information by updating the orbit information based on the GPS information whenever the processor determines that the orbit information is not receivable.

7. The topology generation device of claim 6, wherein the processor is configured to calculate the location of the first low earth orbit satellite by applying six orbital elements of two line elements (TLE) information and simplified general perturbations 4 (SGP4) algorithm.

8. The topology generation device of claim 6, wherein the processor is configured to generate topology calibration information by performing topology calibration based on the updated orbit information and the status information, and generate the network topology for the low earth orbit satellite constellation system based on the location information and the topology calibration information.

9. A topology generating method to be performed a topology generation device for generating topology for a low earth orbit satellite constellation system including a plurality of low earth orbit satellites to be operated in a plurality of orbits, the method comprising:
collecting orbit information for the plurality of orbits in the low earth orbit satellite constellation system from a ground station and collecting status information including statuses of links between the plurality of low earth orbit satellites from the ground station or the plurality of low earth orbit satellites;
generating location information for a first low earth orbit satellite including the topology generation device among the plurality of low earth orbit satellites by predicting a location of the first low earth orbit satellite based on the basis of the orbit information for the plurality of orbits; and
generating a network topology for the low earth orbit satellite constellation system based on the location information for the first low earth orbit satellite and the status information including the statuses of links between the plurality of low earth orbit satellites.

10. The topology generation method of claim 9, further comprising collecting GPS information for the first low earth orbit satellite from a GPS;
updating the location information using the GPS information;
modifying the location information using the orbit information; and
updating the network topology using the status information.

11. The topology generation method of claim 10, further comprising sharing the orbit information and the status information with the plurality of low earth orbit satellites.

12. The topology generation method of claim 11, wherein the plurality of low earth orbit satellites are configured to communicate with at least one of neighboring satellites connected through an inter-plane inter-satellite link or an intra-plane inter-satellite link.

13. The topology generation method of claim 12, further comprising:
transmitting the orbit information and the status information to the at least one of neighboring satellites connected through the inter-plane inter-satellite link and checking whether the at least one of neighboring satellites connected through the inter-plane inter-satellite link receive the orbit information and the status information when the plurality of low earth orbit satellites communicates with the at least one of neighboring satellites connected through the inter-plane inter-satellite link, and
transmitting the orbit information and the status information to the at least one of neighboring satellites connected through the intra-plane inter-satellite link without checking whether the at least one of neighboring satellites connected through the intra-plane inter-satellite link receive the orbit information and the status information when the plurality of low earth orbit satellites communicates with the at least one of neighboring satellites connected through the intra-plane inter-satellite link.

14. The topology generation method of claim 10, wherein generating the location information includes calculating the location of the first low earth orbit satellite based on the orbit information, determining whether the orbit information is receivable, and generating updated orbit information by updating the orbit information based on the GPS information upon determining the orbit information is not receivable.

15. The topology generation method of claim 14, wherein generating the location information includes calculating the location of the first low earth orbit satellite by applying six orbital elements of TLE information and SGP4 algorithm.

16. The topology generation method of claim 14, wherein generating the network topology includes:
generating topology calibration information by performing topology calibration based on the updated orbit information and the status information; and
generating the network topology for the low earth orbit satellite constellation system based on the location information and the topology calibration information.

17. A non-transitory computer readable storage medium storing computer executable instructions which, when executed by one or more processors, cause the one or more processors to perform the method of claim 9.
